(19) United States
(12) Patent Application Publication
(10) Pub. No.: US 2014/0184506 A1
(43) Pub. Date: Jul. 3, 2014

(54) ELECTRO-OPTICAL POINTING DEVICE

(71) Applicant: Vadim V. Golikov, Moscow (RU)

(72) Inventor: Vadim V. Golikov, Moscow (RU)

(21) Appl. No.: 14/128,044

(22) PCT Filed: Nov. 3, 2011
(86) PCT No.: PCT/RU2011/000855

§ 371 Date: Mar. 4, 2014

(30) Foreign Application Priority Data
Jun. 21, 2011 (RU) 2011125329

(51) Int. Cl. G06F 3/0354; G06F 3/03

(52) U.S. Cl. CPC G06F 3/03542; G06F 3/0304
USPC 345/158

(57) ABSTRACT

This utility model relates to systems for interfacing with a computer via control of an image created on a projector screen and can be used for the interaction of a user with the computer during presentations, training sessions or educational events. The electro-optical pointing device comprises a source of radiation in the form of a light wand and a video camera. The video camera is connected to the computer and records the movement of a light spot over the screen, onto which an image being transmitted from the computer is projected. The source of radiation is a laser or a light-emitting diode emitting radiation in the infrared spectral range. An infrared range light filter is mounted in front of the lens of the video camera. The utility model makes it possible to simplify the design of the device whilst maintaining the operational efficiency thereof.

### RELATED APPLICATIONS

This application claims priority to Patent Cooperation Treaty Application number PCT/RU2011/000855, filed on Nov. 3, 2011, which claims priority to Russian patent application serial number RU2011125329 filed on Jun. 21, 2011, and incorporated herewith by reference in its entirety.

### FIELD OF THE INVENTION

This utility model relates to computer control systems (computer user interface systems) and can be used for user's interaction with the computer during presentations or educational events. The present invention includes a method for implementing a user interface function by affecting an image created on a projector screen.

### BACKGROUND OF THE INVENTION

Existing presentation technologies require the presenter to use visual information. The same applies to educational training delivered to a group of listeners. Processing of information displayed by the projector and on the computer connected to the projector must be synchronized.

Most software products for presentations provide tools for users to interact with the content of the presentations. In addition, the presentation often shows the functionality of a program. During the presentation, the presenter can manage the applications on the computer, including working with documents, making changes to the presented material, making notes, etc.

It is difficult, however, to synchronize processing of the information, on the one hand, with visualizing the material rapidly, on the other hand. In addition, the presenter must be further equipped with easel presentation stands or poster stands (flip-boards). Thus, the presenter is forced to constantly move between the computer and a mouse, presentation screen, and flip-boards.

In the case referenced above, the presentation and its perception by the listeners are marred by the following disadvantages:

1. The presenter spends additional time on his or her own movements, including the time needed to move to and bend over the computer periodically.

2. The listeners are forced to switch attention between various and unrelated presentation fragments in which the presenter periodically falls out of sight of the listeners.

3. The presentation fragments are not synchronized, and screen slides run ahead of or behind the notes made on a flip board.

4. The content of the notes is in no way attached to or saved along with the presentation material when necessary.

5. Certain areas of the presentation must be highlighted, and the lights in the room where the listeners are situated must be dimmed.

To eliminate some of the disadvantages, existing additional equipment, such as pen-enabled interactive tablet screens, copying boards, interactive boards, document camera, special Bluetooth pointers, and others, can be used. The disadvantages of such devices are their bulkiness, the complexity of use, and the high price.

Patent U.S. Pat. No. 5,115,230, published on May 19, 1992, IPC G06F 3/00, describes an electro-optical pointing device. A light-pen system that comprises a source of a beam of radiation for forming a spot at a desired location on the screen and an adjunct video camera that is used to detect the location of the spot on the screen and to produce an output signal indicative of the location of the spot. The disadvantages of this device include the need to use special equipment and the complexity of its installation, which disallows a quality presentation in those rooms where only a computer and a projector (or a large monitor) are available.

The goal of the utility model is to eliminate these disadvantages. The technical result entails simplification of the device design while maintaining its efficiency.

### SUMMARY OF THE INVENTION

The problem is solved and the technical result is achieved if in the electro-optical pointing device that comprises a light-pointer used as a source of a beam of radiation and a video camera connected to a computer, which detects the movement of the light spot on the screen onto which the image is transferred from the computer, the source of radiation is a laser or LED, the radiation of which is in the infrared range of the spectrum and there is an infrared filter mounted in front of the camera lens.

### BRIEF DESCRIPTION OF THE DRAWINGS

FIG. 1 shows a source of radiation in the form of a light-pointer;

FIG. 2 shows equipment necessary for the presentation; and

FIG. 3 shows a signal exchange diagram.

### DETAILED DESCRIPTION OF THE PREFERRED EMBODIMENT

The operation of the device is based on the sensitivity of a matrix of the charge-coupled devices (CCD) of most cameras, including cameras of mobile devices and webcams, to light that is invisible to the human eye. In this application, this is infrared (IR) wavelength range. The aforementioned light has a range of wavelengths from 740 nm to 2500 nm. It is preferable, however, to use a range of the light source and filter up to 1,000-1,100 nm since in most CCDs matrices effective sensitivity decreases heavily with a further increase in wavelength. Selecting this range allows highlighting the position of a light point on the color plane using the filter. In this case, the dispersion of laser and diode sources with radiation within the IR range of the spectrum significantly simplifies the retrieval of the components for the proposed device.

The electro-optical pointing device comprises a filter (1) installed in front of a video camera and a light (laser or LED) pointer (2), both operating within the infrared (IR) wavelength range of the spectrum.

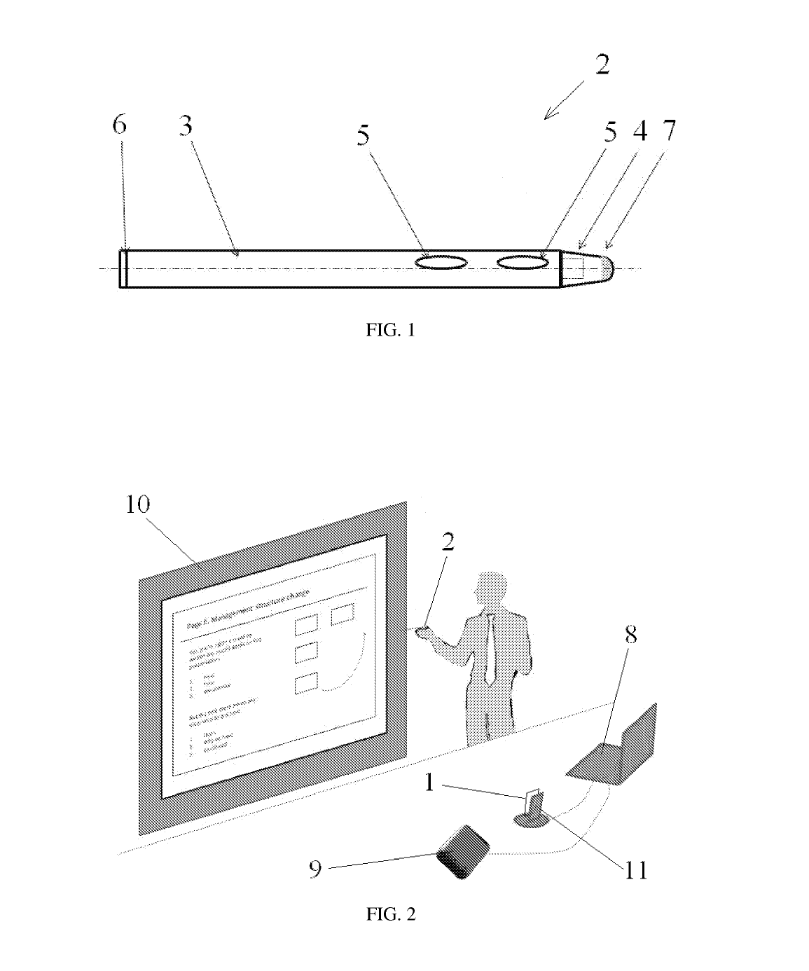

The light pointer (2) (FIG. 1) comprises a housing (3) for the power source (a battery, accumulator, or their set) and a light source (4) (laser IR LEDs or conventional IR LEDs). The housing (3) comprises at least one on/off IR light button (5) (the device may also be equipped with other buttons). A cover for a battery unit (6) may be located on one side of the housing (3). A cap (7) design, if provided, may vary depending on the type of the light source (4).

A place for presentation (FIG. 2) is equipped with a camera (11) in addition to a standard computer (8), projector (9), and screen (10). The presenter has the light pointer (2) in his or her hand, which is used for the presentation and for the cursor movement instructions. A light filter (1) is located in front of the camera (11). The light filter (1) along with the camera (11) serves as a signal receiver from the light source (2) and its movement source for the computer. The camera (11) that is a signal receiver can be a camera built into the computer, a separate camera, or a camera on a mobile device. The presenter can give point-contact cursor movement instructions or draw lines, draw, etc., touching or not touching the screen surface with the emulator, turning the pointer (2) on at the right moments.

The device operates by making marks on the screen (10) with the IR light pointer (2), allocating the filter (1) with the help of IR, and capturing only light pointer (2) signals by the camera (11). The following step will involve the conversion of these signals into commands of the operating system of a computer cursor.

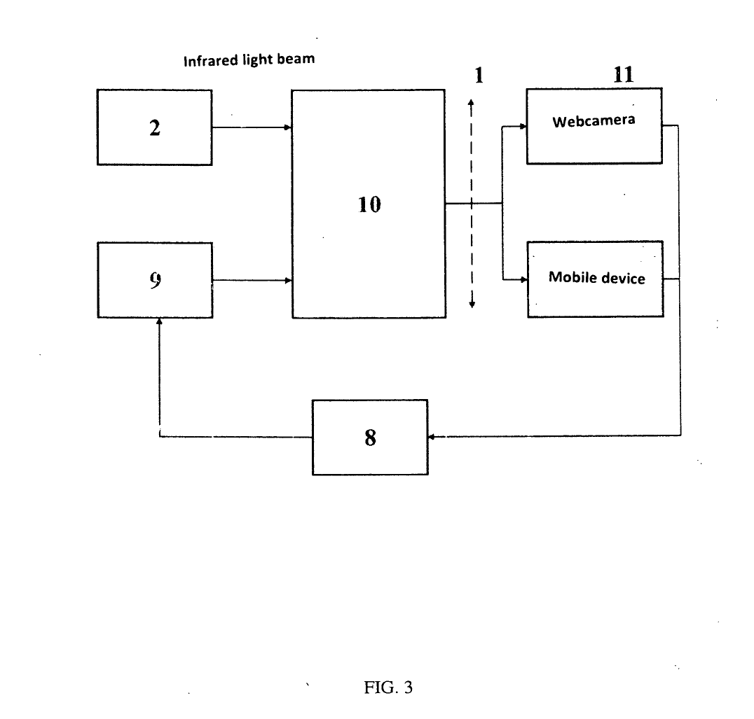

Signal flow and information exchanges are shown in FIG. 3. The computer (8) transmits a signal to the projector (9). The projector (9) projects the image onto the screen (10). An image drawn on the screen (10) with the light pointer (2) enters the camera (11). The camera (11) transmits the position of the light spot from the pointer (2) to the computer in a raw or processed (in the form of X and Y coordinates) form.

Since the projector image and the projection of the visible camera on the screen are rectangular only conditionally, the transformation of the coordinates of the light spot into the computer image coordinates is required. To make this possible, each new relative position of the projector, screen, and camera require calibration. During calibration, four angles are marked that define the coordinate axes and scales on the coordinate axes. The calibration is required only once before each presentation. Since the projector image during the presentation is usually brighter than the background, however, the calibration can be done automatically before the presentation or during the presentation.

The optical signal processing consists of the following steps:

1. [Preparation] Calibrate the coordinates of the projection angles to angles of the visible image of the camera.

2. [The rest of the steps—performed during the presentation] Highlight IR with the help of the signal light filter tool in the form of the light spot.

3. Determine the coordinates of the light spot relative to the visible region of the camera.

4. Transfer data to the computer through the connecting cable or wireless.

5. Process [transform] the coordinates of the light spot in order to get the coordinates relative to the angles of the projector screen and, consequently, the computer.

If an external camera (for example, USB) or a camera built into the computer is used to input optical information from the light pointer device, the computer driver processes the coordinates. The processing power of today's mobile devices is capable not only to transfer information regarding a cursor position to the computer but also to calibrate the visible image and to transfer the coordinates in order to convey the exact position of the light spot relative to the angles of the image on the projector screen and the computer.

Thus, the proposed utility model can easily and quickly adapt any conventional presentation equipment to the tasks of a complex interactive presentation by simply setting the light filter in front of a standard video camera.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electro-optical pointing device cooperable with a computer comprising:
a source of radiation in the form of a light wand and a video camera having lens and operably connected to the computer and adaptable for recording movement of a light spot over a screen, onto which an image being transmitted from the computer is projected, whereby the source of radiation is a laser or a light-emitting diode emitting radiation in the infrared spectral range; and
an infrared range light filter mounted in front of the lens of the video camera.
